(19) United States
(12) Patent Application Publication
(10) Pub. No.: US 2014/0330806 A1
(43) Pub. Date: Nov. 6, 2014

(54) Data traffic amount prompting method and apparatus

(71) Applicant: TENCENT TECHNOLOGY (SHENZHEN) COMPANY LIMITED, Shenzhen (CN)

(72) Inventors: Kequn Cui, Shenzhen (CN); Lei Zhang, Shenzhen (CN)

(21) Appl. No.: 14/120,346

(22) Filed: May 14, 2014

Related U.S. Application Data
(63) Continuation of application No. PCT/CN2013/089442, filed on Dec. 13, 2013.

(30) Foreign Application Priority Data
Apr. 28, 2013 (CN) 2013101560260

(51) Int. Cl. H04L 12/26; G06F 17/30

(52) U.S. Cl. CPC H04L 43/0894; G06F 17/30864
USPC 707/706

(57) ABSTRACT

A data traffic amount prompting method performed at a server is provided, in which a search result, including at least one target web page address, generated by a search engine in response to a search request from a client device is captured, a data traffic amount corresponding to each target web page address is queried in a database, and the search result, together with the data traffic amount corresponding to each target web page address, are returned to the client device. Additionally, a data traffic amount prompting method performed at a terminal device, related data traffic amount prompting apparatuses are also provided.

### CROSS REFERENCE TO RELATED APPLICATIONS

The present patent application is a U.S. continuation application under 35 U.S.C. §111(a) claiming priority under 35 U.S.C. §§120 and 365(c) to International Application No. PCT/CN2013/089442 filed on Dec. 13, 2013, which claims priority of the Chinese patent application No. 201310156026.0, entitled “data traffic amount prompting method and apparatus” and filed by applicant Tencent Technology (Shenzhen) Co., Ltd on Apr. 28, 2013, which is incorporated into the present application by reference in its entity.

### TECHNICAL FIELD

The disclosure generally relates to network communication techniques, and in particular to a data traffic amount prompting method and apparatus.

### BACKGROUND

Search engines have been widely used by people surfing the Internet for quickly finding their desired information. Currently, the most popular search engines may include Baidu and Google, for example. A search engine generally captures and pre-processes a huge amount of web pages to create an index database. In response to a user's search request, the search engine may search the index database for a search result matching the search request and return the search result to the user. The search result may include links to one or more matched web page addresses. Additionally, the search result may also include a brief summary extracted from each matched web page, a title of contents presented in each matched web page, and a latest update time of each matched web page, etc.

The user generally uses a client application (i.e., a software component, for example, a browser, also referred to as a client device in some cases) installed in a terminal device to enjoy the search engine's service. When the user selects to access one of the web page addresses in the search result, the client application would directly link to or invoke another client application to link to the corresponding web page address.

### SUMMARY

This disclosure in some aspects relates to a data traffic amount prompting method, apparatus, capable of prompting a user the specific data traffic amount that may be resulted by accessing a web page address.

According to an aspect of the disclosure, a data traffic amount prompting method is provided, which includes steps as follows: at a server, capturing a search result, including at least one target webpage address, generated by a search engine in response to a search request from a client device; querying a database for a data traffic amount corresponding to each target webpage address; and returning the search result, together with a representation of the data traffic amount corresponding to each target webpage address, to the client device.

According to another aspect of the disclosure, a data traffic amount prompting method is provided, which includes steps as follows: at a terminal device, transmitting a search request to a search engine in response to a user's input; receiving a search result, including at least one target web page address, together with a representation of a data traffic amount corresponding to each target web page address; and presenting the search result together with the representation of the data traffic amount corresponding to each target web page address to the user.

According to another aspect of the disclosure, a data traffic amount prompting apparatus is provided, which includes: a capture module, configured to capture a search result, including at least one target webpage address, generated by a search engine in response to a search request from a client device; a query module, configured to query a database for a data traffic amount corresponding to each target webpage address; and a return module, configured to return the search result, together with a representation of the data traffic amount corresponding to each target webpage address, to the client device.

According to another aspect of the disclosure, a data traffic amount prompting apparatus is provided, which includes: a transmission module, configured to transmit a search request to a search engine in response to a user's input; a reception module, configured to receive a search result, including at least one target web page address, together with a representation of a data traffic amount corresponding to each target web page address; and a present module, configured to present the search result together with the representation of the data traffic amount corresponding to each target web page address to the user.

According to yet another aspect of the disclosure, a server is provided, which includes a processor and a memory coupled to the processor and including instructions that, when executed, cause the processor to perform the following method: capturing a search result, including at least one target webpage address, generated by a search engine in response to a search request from a client device; querying a database for a data traffic amount corresponding to each target webpage address; and returning the search result, together with a representation of the data traffic amount corresponding to each target webpage address, to the client device.

According to yet another aspect of the disclosure, a terminal device is provided, which includes a processor and a memory coupled to the processor and including instructions that, when executed, cause the processor to perform the following method: transmitting a search request to a search engine in response to a user's input; receiving a search result, including at least one target web page address, together with a representation of a data traffic amount corresponding to each target web page address; and presenting the search result together with the representation of the data traffic amount corresponding to each target web page address to the user.

According to yet another aspect of the disclosure, a non-transitory computer-readable storage medium is provided, which includes instructions that, when executed, cause the processor to perform the following method: capturing a search result, including at least one target webpage address, generated by a search engine in response to a search request from a client device; querying a database for a data traffic amount corresponding to each target webpage address; and returning the search result, together with a representation of the data traffic amount corresponding to each target webpage address, to the client device.

According to yet another aspect of the disclosure, a non-transitory computer-readable storage medium is provided, which includes instructions that, when executed, cause the processor to perform the following method: transmitting a search request to a search engine in response to a user's input; receiving a search result, including at least one target web page address, together with a representation of a data traffic amount corresponding to each target web page address; and presenting the search result together with the representation of the data traffic amount corresponding to each target web page address to the user.

This section is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

These and other sample aspects of the disclosure will be described in the detailed description and the claims that follow, and in the accompanying drawings, wherein:

FIG. 1 is a schematic view illustrating a typical scenario in which a data traffic amount prompting method according to some embodiments of the disclosure is implemented;

FIG. 2 is a flow chart illustrating a data traffic amount prompting method according to one embodiment of the disclosure;

FIG. 3 is a flow chart illustrating a data traffic amount prompting method according to another embodiment of the disclosure;

FIG. 4 is a schematic view illustrating a graphical user interface presented according to some embodiments of the disclosure;

FIG. 5 is a flow chart illustrating a data traffic amount prompting method according to yet another embodiment of the disclosure;

FIG. 6 is a flow chart illustrating a data traffic amount prompting method according to yet another embodiment of the disclosure;

FIG. 7 is a flow chart illustrating a data traffic amount prompting method according to yet another embodiment of the disclosure;

FIG. 8 is a flow chart illustrating a data traffic amount prompting method according to yet another embodiment of the disclosure;

FIG. 9 is a schematic view illustrating an example graphical user interface presented according to the some embodiments of the disclosure;

FIG. 10 is a flow chart illustrating a data traffic amount prompting method according to yet another embodiment of the disclosure;

FIG. 11 is a schematic view illustrating an example graphical user interface presented according to some embodiments of the disclosure;

FIG. 12 is a schematic view illustrating an example graphical user interface presented according to some embodiments of the disclosure;

FIG. 13 is a flow chart illustrating a data traffic amount prompting method according to yet another embodiment of the disclosure;

FIG. 14 is a block diagram illustrating a data traffic amount prompting apparatus according to yet another embodiment of the disclosure;

FIG. 15 is a block diagram illustrating a data traffic amount prompting apparatus according to yet another embodiment of the disclosure;

FIG. 16 is a structure schematic view illustrating the data traffic amount prompting apparatus as shown in FIG. 14; and

FIG. 17 is a structure schematic view illustrating the data traffic amount prompting apparatus as shown in FIG. 15.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may include at least one element of a claim.

Reference throughout this specification to “an example,” “an embodiment,” or the like in the singular or plural means that one or more particular features, structures, or characteristics described in connection with an embodiment is included in at least one embodiment of the present disclosure. Thus, the appearances of the phrases “an example,” “an embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the invention herein is for the purpose of describing particular examples only and is not intended to be limiting of the invention. As used in the description of the invention and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

None of the existing search engines provides a search result including a prompt of the data traffic amount that may be resulted by accessing any one of the web page addresses presented in the search result. As a result, specifically in a data-traffic-sensitive application, for example, when a user is surfing the Internet through a 2G/3G mobile network, the user cannot selectively access the web pages, for which a relatively small data traffic amount may be consumed. In this case, the user may consume an unexpected large data traffic amount for accessing some web pages and thus suffer losses.

According to various embodiments of the disclosure, a search result, including at least one target web page address, generated by a search engine in response to a search request from a client device is captured, a data traffic amount corresponding to each target web page address is queried in a database, and the search result, together with the data traffic amount corresponding to each target web page address, are returned to the client device.

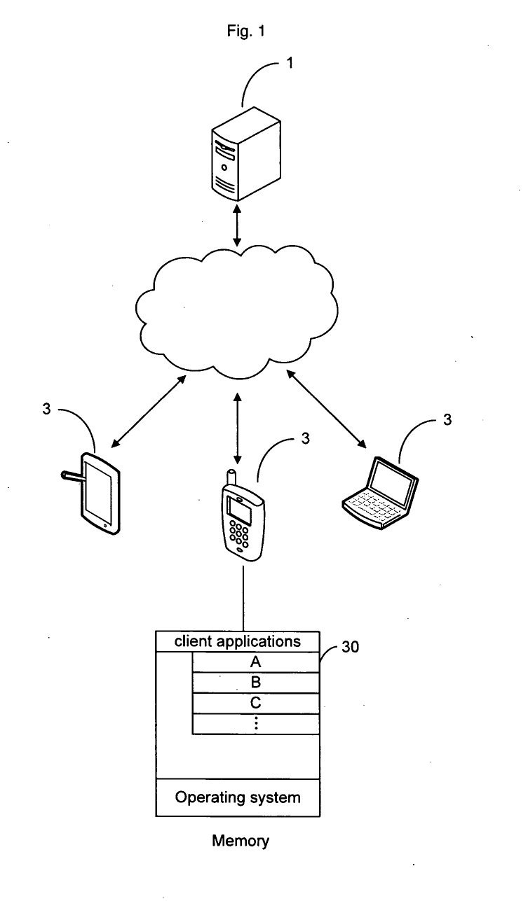

FIG. 1 is a schematic view illustrating a typical scenario in which a data traffic amount prompting method according to some embodiments of the disclosure is implemented.

In the embodiments, the data traffic amount prompting method is performed at a server 1 or at a terminal device 3, or some steps are performed at the server 1 while other steps are performed at the terminal device 3. As shown in FIG. 1, the server 1 communicates with at least one terminal device 3 through a network 2.

The terminal device 3 may be, for example, a desktop computer, a portable computer, a mobile phone, a tablet personal computer, a personal digital assistant, a self-service network terminal or other similar computing devices.

The network 2 may be, for example, Internet, mobile Internet (such as 2G and 3G network provided by telecommunication operators), and a local area network (wired or wireless).

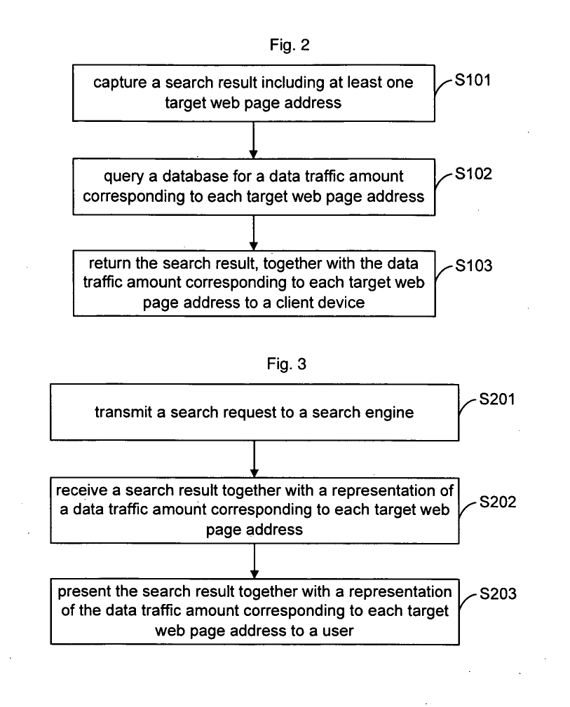

FIG. 2 is a flow chart illustrating a data traffic amount prompting method according to one embodiment of the disclosure. As shown in FIG. 2, the data traffic amount prompting method is performed at the server 1 and includes the following steps.

Step S101: a search result, including at least one target web page address, generated by a search engine in response to a search request from a client device is captured.

Step S102: a data traffic amount corresponding to each target web page address is queried in a database.

Here; the database is a traffic statistical database, in which a plurality of web page addresses are recorded with their respective of data traffic amounts.

Step S103: the search result, together with the data traffic amount corresponding to each target web page address, is returned to a client device for presentation.

According to the data traffic amount prompting method as describe above, the data traffic amount corresponding to the target web page address generated by the search engine is queried and is returned to the client device for presentation together with the search result of the search engine, so that a user may choose to access a web page which may generate a large data traffic amount or not by referring to the search result and the data traffic amount presented by the client device, thereby avoiding unnecessary waste of traffic.

In some examples, details of each step of the method may be implemented as follows.

The search engine mentioned in Step S101 can be set up in the server 1 or in one or more other servers or cloud servers which communicate with the server 1 through a network. For example, the search engine may be Baidu, Google or the like. The client device may refer to the client application 30 running in the terminal device 3, or the terminal device 3 itself. As shown in FIG. 1, the search request is initiated by the client application 30 running in the terminal device 3 in response to a user's manipulation. The client application 30 may be a browser client application, such as a browser installed on a computer or a mobile phone.

When browsing a web page, the user may input a match condition of his/her desired web page to the client application 30, for example, the user may input one or more keywords of his/her desired web page in a search box presented by the client application 30, such as “sweater & knit”, or select a category of his/her desired web page, such as “pop songs” or the like. After receiving the match condition, the client application 30 will initiate a search request based on the match condition to request the search engine to carry out a search and return a search result matching the match condition.

After receiving the search request, the search engine may search a created index database for the search result including at least one target web page address. The target web page address may be a Uniform Resource Locator (URL) of the target web page matching the match condition. In addition to the at least one target web page address, the search result may further include a brief summary extracted from each target web page, a title of contents presented in the target web page, a latest update time of the target web page and the like.

The traffic statistical database mentioned in Step S102 may be created and maintained by the server 1 and is configured to store the data traffic amount corresponding to each web page address collected and recorded by the server 1. The data traffic amount corresponding to the web page address refers to an estimated data traffic amount to be resulted when the client application 30 accesses the web page to which the web page address links. For example, the traffic statistical database may be in a form as follows:

| URL | bytes |
|---|---|
| http://news.qq.com/ | 102500 |

A web page may be updated by a web page designer or a web page surfer at any time, and each client application 30 has a respective parameter setting, for example, the client application 30 may be set to display text contents only and not to display image contents, animation contents and the like when accessing the web page to which the web page address links. In this case, the data traffic amount actually resulted when the web page is accessed is different from that corresponding to the web page address recorded in the traffic statistical database. Therefore, the data traffic amount corresponding to each web page address recorded in the traffic statistic database is actually an estimated amount.

In the embodiment, the data traffic amount corresponding to each web page address can be preset by the designer of web page corresponding to each web page address based on a statistical result or an estimated result when the web page was initially published. The server 1 collects the preset data traffic amount corresponding to each web page address, so as to create the traffic statistical database.

At Step S103, the search result is returned to the client application 30 together with the queried data traffic amount corresponding to each target web page address.

FIG. 3 is a flow chart illustrating a data traffic amount prompting method according to another embodiment of the disclosure. As shown in FIG. 3, the data traffic amount prompting method is performed at the client application 30 in the terminal device 3 and includes the following steps.

Step S201: the client application 30 transmits a search request to a search engine. The search request may include one or more keywords.

Step S202: the client application 30 receives, from the server 1, a search result, including at least one target web page address corresponding to the search request, together with a representation of a data traffic amount corresponding to each target web page address.

Step S203: the client application 30 presents the search result together with a representation of the data traffic amount corresponding to each target web page address to a user.

In an example, the client application 30 parses the returned search result and the data traffic amount corresponding to each target web page address and presents the data traffic amount corresponding to the target web page address and the target web page address in the search result to the user. Accordingly, the user may selectively access some web pages which may generate a relatively small data traffic amount based on the presented data traffic amount corresponding to each target web page address. For example, when the user is surfing the Internet using a mobile phone, he/she can avoid accessing non mobile-phone-customized web pages, thereby saving data traffic.

Generally, the target web page addresses in the search result are presented by the client application 30 in a form of link. When the user desires to access a web page corresponding to one of the target web page addresses, he/she only has to select the link of the corresponding target web page address.

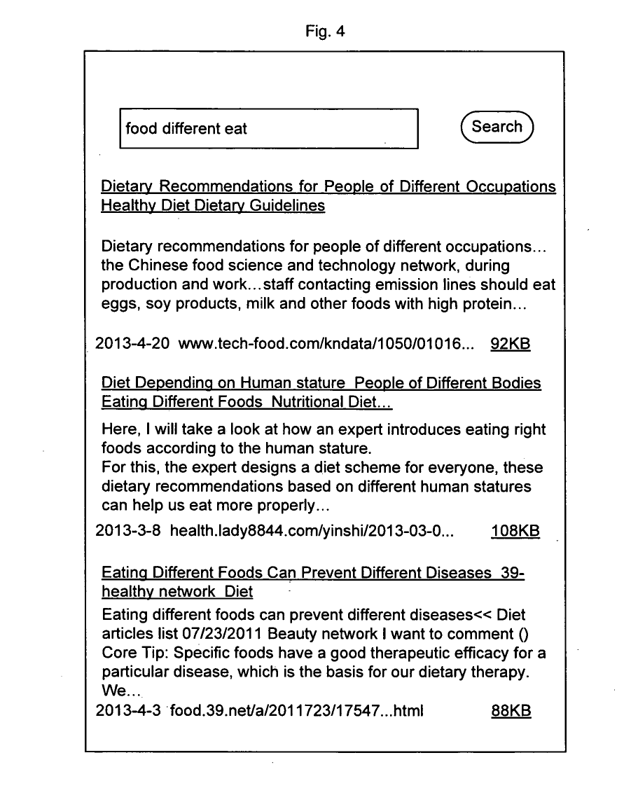

In an example, as shown in FIG. 4, the representation (92 KB, 108 KB, 88 KB) of the data traffic amount corresponding to each target web page address may be presented at the end of the corresponding target web page address in the form of link.

In the embodiment described with reference to FIG. 2, the traffic statistical database is created by collecting the preset data traffic amount corresponding to each web page address. However, since the web page may be updated at any time, the data traffic amount corresponding to each web page address may be changed dynamically. Therefore, if the data traffic amount corresponding to each web page address recorded in the traffic statistical database is not updated accordingly, there may be a large difference between the recorded data traffic amount and that actually resulted due to accessing the web page. When the data traffic amount corresponding to the target web page address presented by the client application 30 becomes of low accuracy, it becomes of little value for reference by the user.

In addition, due to the large amount of information in the Internet, if only the server 1 is utilized to collect the preset or updated data traffic amount corresponding to each web page address, much pressure and burden may be brought to the server 1 and the collection result may be not comprehensive enough.

The following embodiment of the disclosure successfully solves this problem. It improves the accuracy of the presented data traffic amount, improves the value for reference, reduces the pressure and burden of the server 1 and effectively enriches the data in the traffic statistic database.

FIG. 5 is a flow chart illustrating a data traffic amount prompting method according to yet another embodiment of the disclosure. As shown in FIG. 5, in the embodiment of the disclosure, another data traffic amount prompting method is provided, which is performed at the server 1. Compared with the data traffic amount prompting method according to the embodiment described with reference to FIG. 2, in the present embodiment, the data traffic amount prompting method further includes the following steps after Step S103.

Step S104: a traffic amount report is received from the client application 30. The traffic report is generated by the client application 30 recording the data traffic amount resulted by accessing each target web page address.

Step S105: the data traffic amount corresponding to the respective web page address is updated in the traffic statistical database according to the traffic amount report.

In an example, the traffic report in Step S104 includes the data traffic amount resulted by accessing the corresponding target web page address, which are acquired by the client application 30 or a data traffic statistical program embedded in the client application 30. After receiving and presenting the search result and the data traffic amount corresponding to each target web page address, the client application 30, in response to the user's manipulation, links to or invokes another client application to link to the corresponding target web page address, so as to load the web page corresponding to the target web page address. Whenever accessing a target web page address, the client application 30 records the data traffic amount resulted by accessing the target web page address and then sends the recorded data traffic amount to the server 1.

At Step S105, the data traffic amount actually resulted when the client application 30 accesses the corresponding target web page address is included in the traffic report, so that it is possible for the data traffic amount corresponding to the corresponding web page address in the traffic statistical database to be updated according to the traffic amount report, and thus the data traffic amount corresponding to the web page address recorded in the traffic statistical database may become accurate. Accordingly, the accuracy, and thus value for reference, of the presented data traffic amount corresponding to the target web page address are improved when the data traffic amount prompting method according to the embodiment of the disclosure is executed next time.

In addition, the data in the traffic statistical database can be effectively enriched since the traffic statistical database is maintained and updated through the traffic report uploaded by the client application 30, which is located at terminal devices of a significant number of Internet users, and accordingly, data from the significant number of Internet users can be shared.

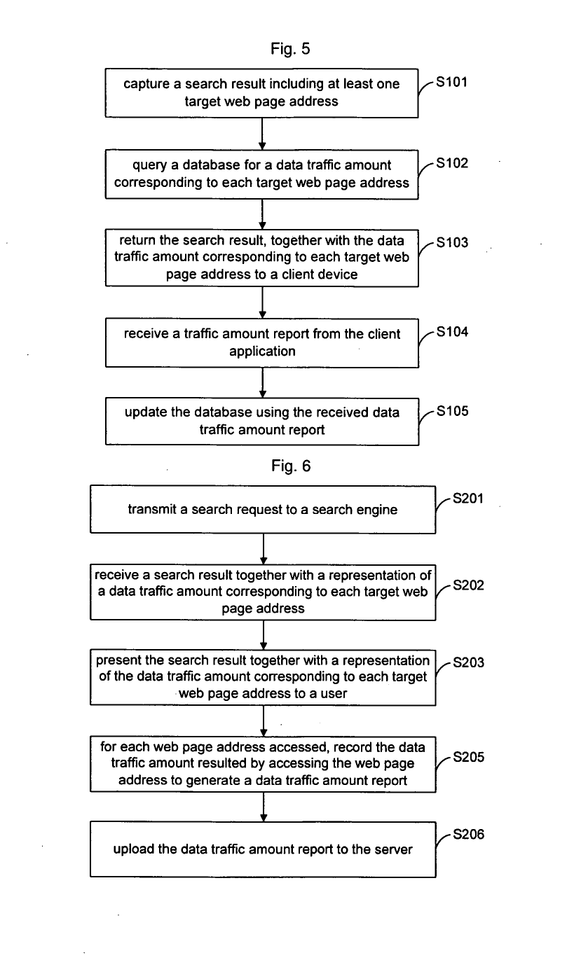

FIG. 6 is a flow chart illustrating a data traffic amount prompting method according to yet another embodiment of the disclosure. Compared with the data traffic amount prompting method according to the embodiment described with reference to FIG. 3, in the present embodiment, the data traffic amount prompting method further includes the following steps.

Step S204: for each web page address accessed, the data traffic amount resulted by accessing the web page address is recorded to generate a data traffic amount report.

Step S205: the client application 30 uploads the data traffic amount report to the server 1.

As described above, in the embodiment described with reference to FIG. 5, when a web page address is accessed, the client application 30 or a data traffic statistical program embedded in the client application 30 records the data traffic amount corresponding to the web page address. In an example, after presenting the search result and the data traffic amount corresponding to each target web page address, the client application 30, in response to the user's manipulation, links to or invokes another client application to link to the corresponding target web page address, so as to load the web page corresponding to the target web page address. Whenever a target web page address is accessed, the client application 30 records the data traffic amount resulted by accessing the target web page address and then sends the recorded data traffic amount to the server 1.

According to the data traffic amount prompting method of the embodiment described with reference to FIG. 2, the search result of the search engine is presented together with the data traffic amount corresponding to the target web page address, and the presented data traffic amount can play a prompting role on the user: generally, before selecting a link to a target web page address to access the corresponding target web page, the user may view the data traffic amount corresponding to the target web page address and then determine whether the data traffic amount is too large, if yes, the user can select not to access the target web page address.

However, in some cases, when browsing the significant number of target web page addresses from the search result, the user may easily neglect the large data traffic amount corresponding to a certain target web page address because of fatigue or carelessness and improperly select the target web page to access, thereby wasting data traffic.

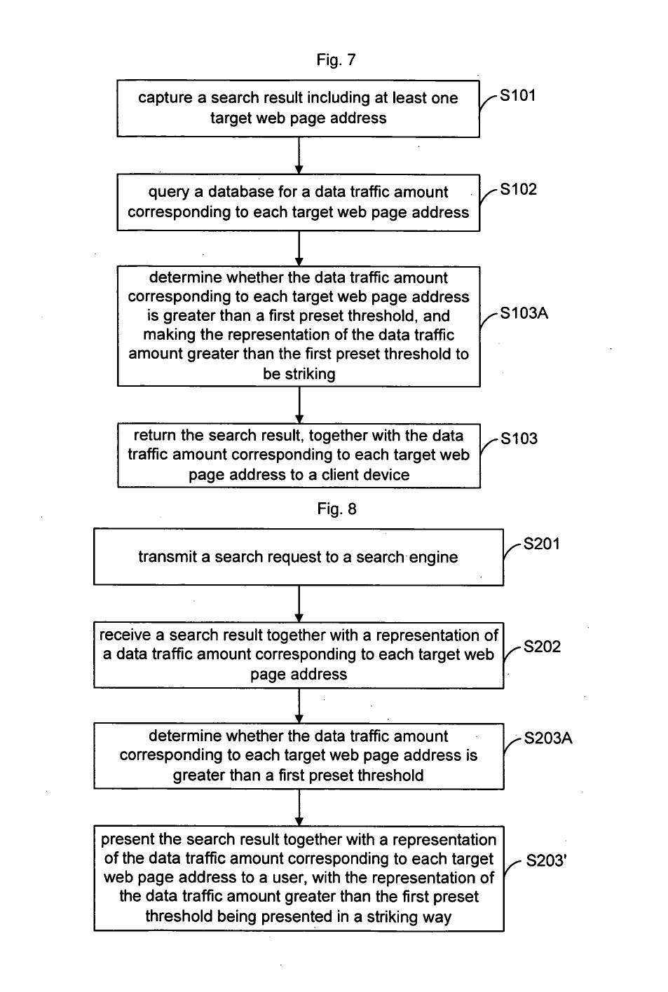

The following embodiment of the disclosure successfully solves this problem. As shown in FIG. 7, the embodiment of the disclosure provides another data traffic amount prompting method. Compared with the data traffic amount prompting method according to the embodiment described with reference to FIG. 5, in the present embodiment, the data traffic amount prompting method further includes the following step before Step S103.

Step S103A: it is determined whether the data traffic amount corresponding to each target web page address is greater than a first preset threshold, and representation of the data traffic amount greater than the first preset threshold is made to be striking.

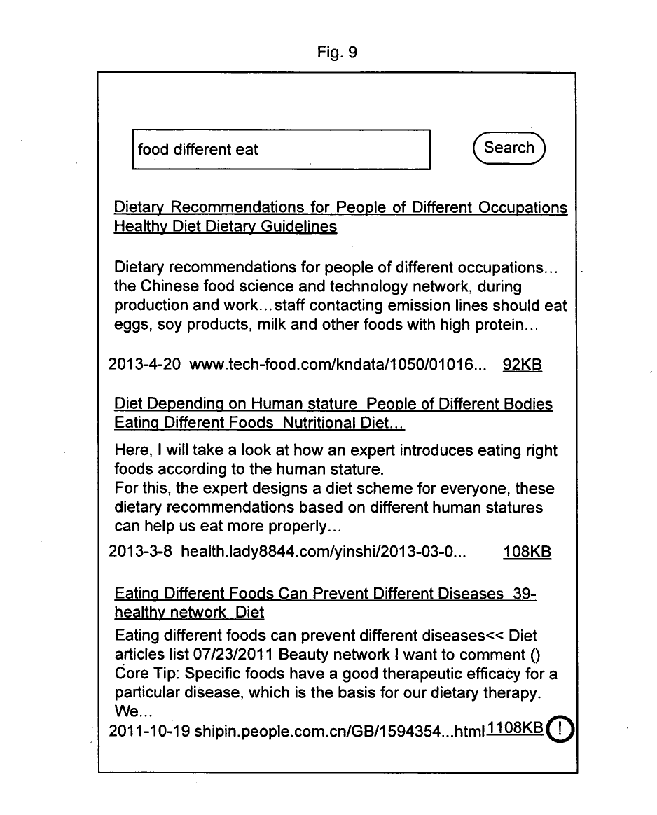

For example, a highlighted mark may be set for the data traffic amount greater than the first preset threshold. Specifically, the first preset threshold may be a default value set by the server 1 or a value set by the client application 30 according to the user's personalized configuration and uploaded to the server 1. In one example, the highlighted mark may be implemented by setting the font color of the data traffic amount greater than the first preset threshold presented as a highlighted color, such as the bright red color. In one example, the highlighted mark may be implemented by bolding or enlarging the display font of the data traffic amount greater than the first preset threshold to a highlighted extent. In another example, the highlighted mark may be implemented by displaying a highlighted symbol, character or pattern, such as a bright red exclamation mark, or a cartoon character holding a warning board, near the data traffic amount greater than the first preset threshold, for example, at a position next to the end of the representation of the data traffic amount, as shown in FIG. 9.

In view of the above, according to the data traffic amount prompting method in the embodiment described with reference to FIG. 5, the user can be further prompted to avoid accessing web pages which may generate a large data traffic amount by setting a highlighted mark for the data traffic amount corresponding to the target web page address greater than the first preset threshold, thereby saving data traffic.

FIG. 8 is a flow chart illustrating a data traffic amount prompting method according to yet another embodiment of the disclosure.

The present embodiment of the disclosure provides another data traffic amount prompting method which implements a similar effect to that in the embodiment described with reference to FIG. 7. The difference lies in that the operation is performed at the client application 30 in the terminal device 3.

Compared with the data traffic amount prompting method according to the embodiment described with reference to FIG. 6, in the present embodiment, as shown in FIG. 8, the data traffic amount prompting method further includes the following step after Step 202.

Step 203A: the client application 30 determines whether the data traffic amount corresponding to each target web page address is greater than a first preset threshold.

Accordingly, Step S203 is the embodiment described with reference to FIG. 3 is changed to Step S203′ here.

In Step S203′, if there is a target web page address corresponding to a data traffic amount greater than a first preset threshold, the representation of the data traffic amount greater than the first preset threshold is presented in a striking way.

For example, a highlighted mark may be set for the data traffic amount greater than the first preset threshold. Specifically, the first preset threshold may be a default value set by the client application 30 or a value set according to the user's personalized configuration. In one example, the highlighted mark may be implemented by setting the font color of the data traffic amount greater than the first preset threshold presented as a highlighted color, such as the bright red color. In one example, the highlighted mark may be implemented by bolding or enlarging the display font of the data traffic amount greater than the first preset threshold to a highlighted extent. In another example, the highlighted mark may be implemented by displaying a highlighted symbol, character or pattern, such as a bright red exclamation mark, or a cartoon character holding a warning board, near the data traffic amount greater than the first preset threshold, for example, at a position next to the end of the representation of the data traffic amount, as shown in FIG. 9.

In view of the above, according to the data traffic amount prompting method in the embodiment described with reference to FIG. 8, the user can be further prompted to avoid accessing web pages which may generate a large data traffic amount by setting a highlighted mark for the data traffic amount corresponding to the target web page address greater than the first preset threshold, thereby saving data traffic.

According to the data traffic amount prompting method of the embodiments described with reference to FIGS. 2 and 3, the search result of the search engine is presented together with the data traffic amount corresponding to the target web page address, and the presented data traffic amount can play a prompting role on the user. However, in some cases, when browsing the significant number of target web pages from the search result, the user may easily neglect the large data traffic amount corresponding to a certain target web page address because of fatigue or carelessness and improperly select the target web page to access, thereby wasting data traffic.

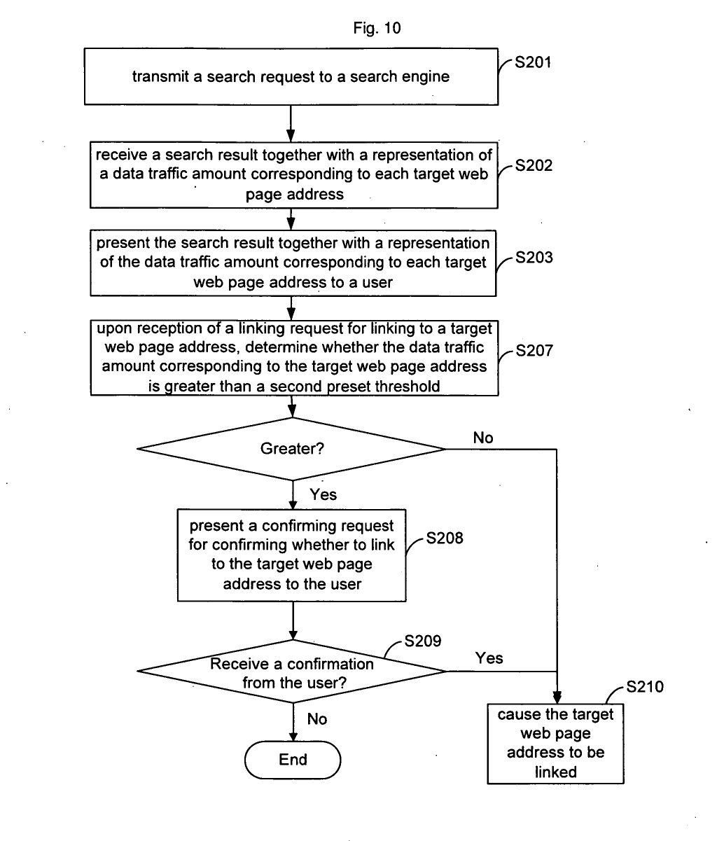

The following embodiment of the disclosure successfully solves this problem. FIG. 10 is a flow chart illustrating a data traffic amount prompting method according to yet another embodiment of the disclosure. As shown in FIG. 10, the present embodiment of the disclosure provides another data traffic amount prompting method, which is performed at the terminal device 3. Compared with the data traffic amount prompting method of the embodiment described with reference to FIG. 2, in this embodiment, the client application 30 further executes the following steps after Step S203.

Step S207: upon reception of a linking request for linking to a target web page address, it is determined whether the data traffic amount corresponding to the target web page address is greater than a second preset threshold. If yes, the method turns to Step S208, and if no, the method turns to Step S210.

Step S208: a confirming request for confirming whether to link to the target web page address is presented to the user.

Step S209: it is determined whether a confirmation for linking to the target web page address is received from the user. If yes, the method turns to Steps S209, and if no, the method ends.

Step S210: the client application 30 causes the target web page address to be linked.

In some examples, details of each step in the method are implemented as follows:

At Step S207, when selecting one of the target web page addresses presented by the client application 30, the user initiates a linking request for linking to the target web page address. The second preset threshold can be a default value set by the client application 30 or a value set by the client application 30 according to the user's personalized configuration.

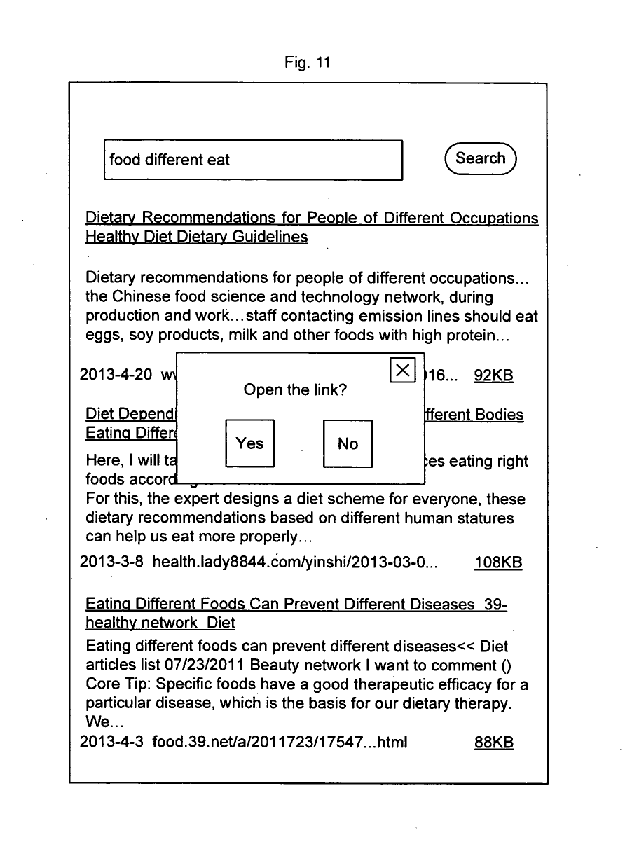

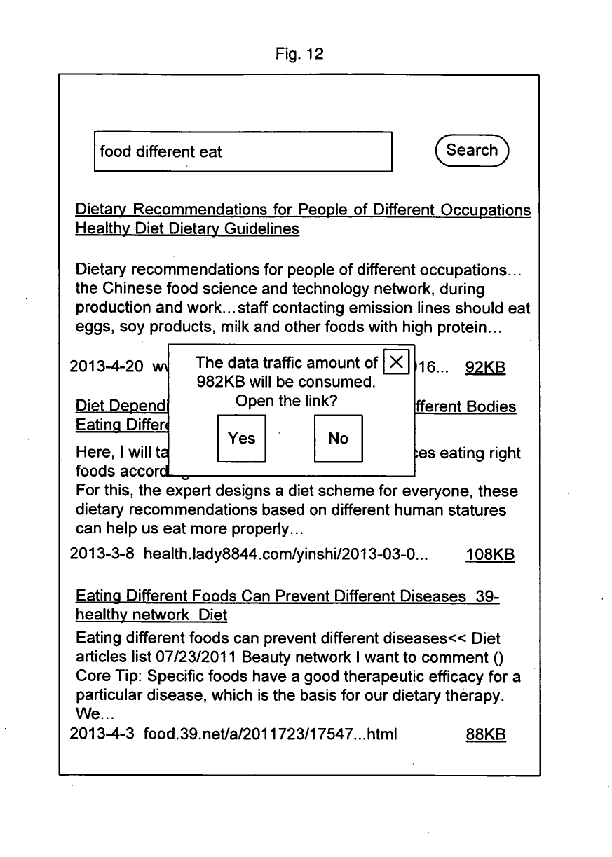

At Step S208, the confirming request may be, for example, a dialog box, in which options for confirming whether to link to the target web page address are presented, as shown in FIG. 11. The user can select an option in the dialog box to confirm whether to link to the target web page address. In another example, the confirming request may further include the data traffic amount corresponding to the target web page address, so that the user may conveniently confirm whether to link to the target web page address according to the data traffic amount corresponding to the target web page address included in the confirming request, as shown in FIG. 12.

At Step S209, for example, if the user selects an option “Yes” in the dialog box, i.e., the client application 30 receives the confirmation for linking to the target web page address, and accordingly, at Step S210, the client application 30 links to or invokes another client application to link to the target web page address according to the confirmation. If at Step S209, the client application 30 receives the confirmation for not linking to the target web page address, for example, the user closes the dialog box or selects an option “No” in the dialog box, the client application 30 give ups linking to the target web page address and the method ends.

In view of the above, according to the data traffic amount prompting method of the present embodiment, the client application 30 can request the user to confirm whether to link to the target web page address upon reception of the linking request for linking to the target web page address and does not link to the target web page address unless the user confirms linking to the target web page address, so that it may be avoided that the user improperly accesses a web page which may generate a large data traffic amount, thereby saving data traffic.

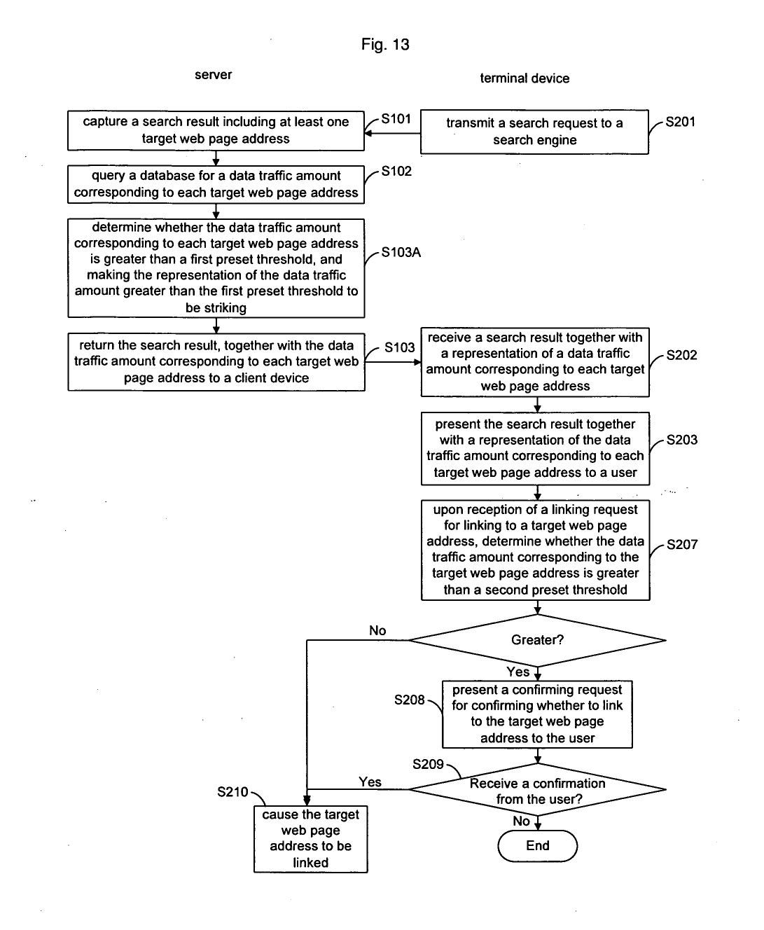

FIG. 13 is a flow chart illustrating a data traffic amount prompting method according to an embodiment of the disclosure. As shown in FIG. 13, the present embodiment of the disclosure provides a data traffic amount prompting method which combines the embodiments described with reference to FIGS. 7 and 10. As described above, the method according to the embodiment described with reference to FIG. 7 is performed at the server 1, and the method according to the embodiment described with reference to FIG. 10 is performed at the terminal device 3. Therefore, the present embodiment of the disclosure presents a method in which some steps are performed at the server 1 and other steps are performed at the terminal device 3, which cooperate with each other to implement the data traffic amount prompting function. The method includes the following steps.

Step S201: the client application 30 transmits a search request to a search engine.

Step S101: the server 1 captures a search result, including at least one target web page address, generated by a search engine in response to a search request from a client application.

Step S102: the server 1 queries a database for a data traffic amount corresponding to each target web page address.

Step S103A: the server 1 determines whether the data traffic amount corresponding to each target web page address is greater than a first preset threshold, and makes the representation of the data traffic amount greater than the first preset threshold to be striking.

Step S103: the server 1 returns the search result, together with the data traffic amount corresponding to each target web page address to the client application 30 for presentation.

Step S202: the client application 30 receives, from the server 1, a search result, including at least one target web page address corresponding to the search request, together with a representation of a data traffic amount corresponding to each target web page address.

Step S203: the client application 30 presents the search result together with a representation of the data traffic amount corresponding to each target web page address to a user.

Step S207: upon reception of a linking request for linking to a target web page address, the client application 30 determines whether the data traffic amount corresponding to the target web page address is greater than a second preset threshold. If yes, the method turns to Step S208, and if no, the method turns to Step S210.

Step S208: the client application 30 presents a confirming request for confirming whether to link to the target web page address to the user.

Step S209: the client application 30 determines whether a confirmation for linking to the target web page address is received from the user. If yes, the method turns to Steps S210, and if no, the method ends.

Step S210: the client application 30 causes the target web page address to be linked.

According to the data traffic amount prompting method provided by the present embodiment of the disclosure, the data traffic amount corresponding to the target web page address greater than the first preset threshold is presented by, for example, a highlighted mark, and the client application 30 requests the user to confirm whether to link to the target web page address upon reception of a linking request for linking to the target web page address and does not link to the target web page address unless the user confirms linking to the target web page address, so that the user can be further prompted to avoid accessing a web page which may generate a large data traffic amount, thereby saving data traffic.

Additionally, as understood by one of ordinary skill in the art, the above embodiments described with reference to FIGS. 2, 3, 5 to 8, 10 can be combined with each other in any manner, unless there is any contradiction, and their combination is not limited to the embodiment described with reference to FIG. 13.

Although FIGS. 2, 3, 5, 6, 7, 8, 10, 13 illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives.

Moreover, the ordinary skilled in the art may understand that all or part of the flow in the method of the embodiments may be implemented through associated hardware controlled by computer programs, which may be stored in a non-transitory computer readable storage medium and may when executed include the flow mentioned in the embodiments of the above methods. In an example, the computer readable storage medium may implement at least some portions of the memory. For example, the computer readable storage medium may include both ROM and RAM. The computer readable storage medium may be implemented as a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or any other suitable computer-readable storage medium.

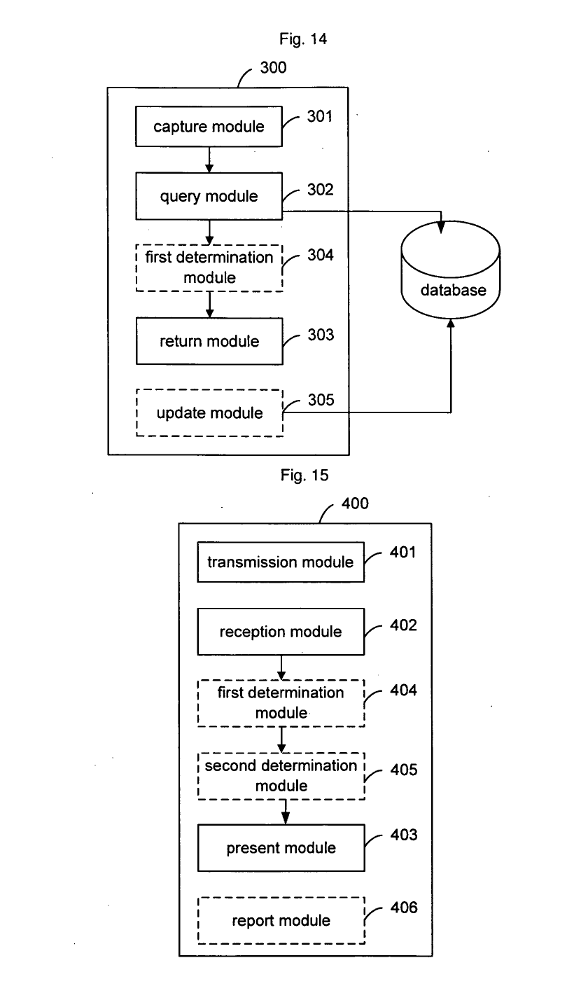

FIG. 14 is a block diagram illustrating a data traffic amount prompting apparatus according to yet another embodiment of the disclosure. As shown in FIG. 14, a data traffic amount prompting apparatus 300 is provided, which includes a capture module 301, a query module 302 and a return module 303. It should be understood that each module mentioned above refers to a computer program or a program segment, and is configured to execute one or more specific functions. In addition, the difference between the modules above does not mean that actual program codes must be separated.

The capture module 301 is configured to capture a search result, including at least one target web page address, generated by a search engine in response to a search request from a client application.

The query module 302 is configured to query a database for a data traffic amount corresponding to each target web page address. The database may be a traffic statistical database in which the data traffic amount corresponding to each web page address is recorded. The traffic statistical database may be created by the server 1 through collecting a preset data traffic amount corresponding to each web page address.

The return module 303 is configured to return the search result together with the data traffic amount corresponding to each target web page address to the client application 30.

The specific operations of the modules may refer to the data traffic amount prompting method according to the embodiment described with reference to FIG. 2 and are omitted here.

In view of the above, according to the data traffic amount prompting apparatus of the embodiment described with reference to FIG. 14, the data traffic amount corresponding to the target web page address generated by the search engine is queried and is returned to the client application 30 for presentation together with the search result of the search engine, so that a user may choose to access a web page which may generate a large data traffic amount or not by referring to the search result and the data traffic amount presented by the client application 30, thereby avoiding unnecessary waste of traffic.

Optionally, the data traffic prompting apparatus 300 may further include a first determination module 304 which is executed before the return module 303. The first determination module 304 is configured to determine whether the data traffic amount corresponding to each target web page address is greater than a first preset threshold, and to make the representation of the data traffic amount greater than the first preset threshold to be striking.

In an example, the data traffic amount corresponding to the target web page address greater than the first preset threshold is presented with the highlighted mark. This can further prompt the user to avoid accessing a web page which may generate a large data traffic amount, thereby saving data traffic.

Optionally, the data traffic prompting apparatus 300 may also include an update module 305, configured to receive a traffic report from the client application 30. The traffic report includes one or more web page addresses that have been accessed and corresponding data traffic amounts resulted by accessing the web page. The update module 305 is also configured to update the database using the received data traffic amount report.

Accordingly, the accuracy of the data traffic amount corresponding to the web page address recorded in the traffic statistical database can be improved, which reduces the pressure and burden of the server 1 and effectively enrich the database.

In an embodiment of the disclosure, as shown in FIG. 15, a data traffic amount prompting apparatus 400 is provided, which includes a transmission module 401, a reception module 402 and a present module 403. It should be understood that each module mentioned above refers to a computer program or a program segment, and is configured to execute one or more specific functions. In addition, the difference between the modules above does not mean that actual program codes must be separated.

The transmission module 401 is configured to transmit a search request to a search engine.

The reception module 402 is configured to receive, from a server, a search result, including at least one target web page address corresponding to the search request, together with a representation of a data traffic amount corresponding to each target web page address.

The present module 403 is configured to present the search result together with the representation of the data traffic amount corresponding to each target web page address to a user.

In an example, each representation of the data traffic amount is presented at the end of the corresponding target web page address.

Optionally, in an example, the data traffic amount prompting apparatus 400 may further include a first determination module 404, configured to determine whether the data traffic amount corresponding to each target web page address is greater than a first preset threshold. In this example, the present module 403 presents the representation of the data traffic amount greater than the first preset threshold to the user in a striking way.

Optionally, in an example, the data traffic amount prompting apparatus 400 may further include a second determination module 405, configured to, upon reception of a linking request for linking to one of the at least one target web page address, determine whether the data traffic amount corresponding to the target web page address is greater than a second preset threshold. In this example, the present module is further configured to, when the data traffic amount corresponding to the target web page address is greater than the second preset threshold, present a confirming request to the user for confirming whether to link to the target web page address. When a confirmation for linking to the target web page address is received from the user, the data traffic amount prompting apparatus causes the target web page address to be linked.

In the above example, the client application 30 further requests the user to confirm whether to link to the target web page address upon reception of a linking request for linking to the target web page address, and does not link to the target web page address unless the user confirms linking to the target web page address, so that the user would not improperly access a web page which may generate a large data traffic amount, thereby saving data traffic.

Optionally, in an example, the data traffic amount prompting apparatus 400 may further include a report module 406, configured to generate a data traffic amount report including one or more web page addresses that have been accessed and corresponding data traffic amounts resulted by accessing the web page addresses, and to upload the generated data traffic amount report to the server 1.

Accordingly, the accuracy of the presented data traffic amount is improved, thus improving the value for reference, the pressure and burden of the server 1 are reduced and the data in the database are effectively enriched.

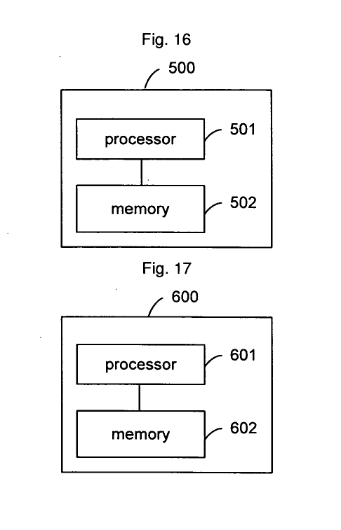

FIG. 16 is a structure schematic view illustrating the data traffic amount prompting apparatus as shown in FIG. 14.

Herein, the data traffic amount prompting apparatus 300 is implemented as a computer equipment 500. This disclosure contemplates any suitable types of computer equipments 500 for implementing the data traffic amount prompting apparatus 300. As example and not by way of limitation, the computer equipment 400 may include one or more servers 1. In an example, software running on the one or more servers performs one or more steps of the method as described referring to FIGS. 2, 5, 7, 13 or implements functions of the various modules as described referring to FIG. 14.

In an example, the computer equipment 500 includes a processor 501 and a memory 502. Although this disclosure describes and illustrates a particular computer equipment having a particular number of particular components in a particular arrangement, any suitable computer equipment having any suitable number of any suitable components can be contemplated.

In an example, the processor 501 includes hardware for executing instructions, for example, one or more computer programs. The processor 501 may retrieve instructions from the memory 502 and execute them. The processor 501 may be implemented as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform one or more of the method steps as described referring to FIGS. 2, 5, 7, 13 or to implement the various modules as described referring to FIG. 14.

In an example, the memory 502 may store instructions for the processor 501 to execute or data for the processor 502 to operate on. In an example, the memory 502 may include random access memory (RAM), which may be dynamic RAM (DRAM) or static RAM (SRAM) as desired. Additionally, the memory 502 may include storage for storing data and instructions, such as read-only memory (ROM), such as mask-programmed ROM, programmable ROM (PROM), erasable PROM (EPROM), electrically erasable PROM (EEPROM), electrically alterable ROM (EAROM), or flash memory. In an example, the storage may be internal or external to computer equipment 500. In an example, the storage stores instructions for performing one or more of the method steps as described referring to FIGS. 2, 5, 7, 13 or for implementing the various modules as described referring to FIG. 14. As an example and not by way limitation, the computer equipment 500 may load instructions from the storage or other sources (for example, remote sources) to the RAM, and then the processor 501 may retrieve the instructions from the RAM to execute them. In an example, the memory 502 may include one or more memories.

FIG. 17 is a structure schematic view illustrating the data traffic amount prompting apparatus as shown in FIG. 15.

Herein, the data traffic amount prompting apparatus 400 is implemented as a computer equipment 600. This disclosure contemplates any suitable types of computer equipments 600 for implementing the data traffic amount prompting apparatus 400. As example and not by way of limitation, the computer equipment 600 may include a terminal device 3, for example, a mobile phone, a personal digital assistant (PDA), a desktop computer, a tablet personal computer, a handheld device having wireless connection capability, a vehicle intelligent terminal, etc. In an example, software running on the terminal device 3 performs one or more steps of the method as described referring to FIGS. 3, 6, 8, 10, 13 or implements functions of the various modules as described referring to FIG. 15.

In an example, the computer equipment 600 includes a processor 601 and a memory 602. The physical characteristics of the processor 601 and the memory 602 may be similar to those of the processor 501 and the memory 502 respectively, and thus descriptions thereof are omitted here.

Herein, one or more non-transitory computer readable storage media may be contemplated for implementing any suitable storage. In an example, a non-transitory computer readable storage medium may implement at least some portions of the memory 502 or 602. The non-transitory computer readable storage medium may be implemented as a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a SECURE DIGITAL card, a SECURE DIGITAL drive, or any other suitable computer-readable storage medium. The non-transitory computer readable storage medium may carry instructions, which when executed, causes at least one of the data traffic prompting methods provided in the disclosure to be performed.

While the foregoing disclosure discusses illustrative aspects and/or embodiments, it should be noted that various changes and modifications could be made herein without departing from the scope of the described aspects and/or embodiments as defined by the appended claims.

1. A data traffic amount prompting method, comprising:
at a server,
capturing a search result, including at least one target webpage address, generated by a search engine in response to a search request from a client device;
querying a database for a data traffic amount corresponding to each target webpage address; and
returning the search result, together with a representation of the data traffic amount corresponding to each target webpage address, to the client device.

2. The data traffic amount prompting method according to claim 1, further comprising: before said returning,
determining whether the data traffic amount corresponding to each target web page address is greater than a first preset threshold; and
making the representation of the data traffic amount greater than the first preset threshold to be striking.

3. The data traffic amount prompting method according to claim 1, wherein the database is set up by collecting a preset representation of the data traffic amount corresponding to each web page address.

4. The data traffic amount prompting method according to claim 1, further comprising:
receiving, from the client device, a data traffic amount report, including one or more web page addresses that have been accessed and corresponding data traffic amounts resulted by accessing the Web page addresses; and
updating the database using the received data traffic amount report.

5. A data traffic amount prompting method, comprising:
at a terminal device,
transmitting a search request to a search engine;
receiving, from a server, a search result, including at least one target web page address corresponding to the search request, together with a representation of a data traffic amount corresponding to each target web page address;
presenting the search result together with the representation of the data traffic amount corresponding to each target web page address to a user of the terminal device.

6. The data traffic amount prompting method according to claim 5, wherein each representation of the data traffic amount is presented at the end of the corresponding target web page address.

7. The data traffic amount prompting method according to claim 5, further comprising:
determining whether the data traffic amount corresponding to each target web page address is greater than a first preset threshold,
wherein the representation of the data traffic amount greater than the first preset threshold is presented to the user in a striking way.

8. The data traffic amount prompting method according to claim 5, further comprising:
upon reception of a linking request for linking to one of the at least one target web page address, determining whether the data traffic amount corresponding to the target web page address is greater than a second preset threshold;
when the data traffic amount corresponding to the target web page address is greater than the second preset threshold, presenting a confirming request to the user for confirming whether to link to the target web page address;
upon reception of a confirmation for linking to the target web page address from the user, causing the target web page address to be linked.

9. The data traffic amount prompting method according to claim 8, wherein the confirming request contains the representation of the data traffic amount corresponding to the target web page address to be linked.

10. The data traffic amount prompting method according to claim 5, further comprising:
generating a data traffic amount report including one or more web page addresses that have been accessed and corresponding data traffic amounts resulted by accessing the web page addresses; and
uploading the generated data traffic amount report to the server.

11. A server, comprising:
a processor; and
a memory, coupled to the processor, and including instructions that when executed, cause the processor to:
capture a search result, including at least one target webpage address, generated by a search engine in response to a search request from a client device;
query a database for a data traffic amount corresponding to each target webpage address; and
return the search result, together with a representation of the data traffic amount corresponding to each target webpage address, to the client device.

12. A terminal device, comprising:
a processor; and
a memory, coupled to the processor, and including instructions that when executed, cause the processor to:
transmit a search request to a search engine;
receive, from a server, a search result, including at least one target web page address corresponding to the search request, together with a representation of a data traffic amount corresponding to each target web page address;
present the search result together with the representation of the data traffic amount corresponding to each target web page address to a user of the terminal device.

13. The server according to claim 11, wherein the memory further includes instructions that when executed, cause the processor to:
before said return,
determine whether the data traffic amount corresponding to each target web page address is greater than a first preset threshold; and
make the representation of the data traffic amount greater than the first preset threshold to be striking.

14. The server according to claim 11, wherein the database is set up by collecting a preset representation of the data traffic amount corresponding to each web page address.

15. The server according to claim 11, wherein the memory further includes instructions that when executed, cause the processor to:
receive, from the client device, a data traffic amount report, including one or more web page addresses that have been accessed and corresponding data traffic amounts resulted by accessing the web page addresses; and
update the database using the received data traffic amount report.

16. The terminal device according to claim 12, wherein each representation of the data traffic amount is presented at the end of the corresponding target web page address.

17. The terminal device according to claim 12, wherein the memory further includes instructions that when executed, cause the processor to determine whether the data traffic amount corresponding to each target web page address is greater than a first preset threshold,
wherein the representation of the data traffic amount greater than the first preset threshold is presented to the user in a striking way.

18. The terminal device according to claim 12, wherein the memory further includes instructions that when executed, cause the processor to:
upon reception of a linking request for linking to one of the at least one target web page address, determine whether the data traffic amount corresponding to the target web page address is greater than a second preset threshold;
when the data traffic amount corresponding to the target web page address is greater than the second preset threshold, present a confirming request to the user for confirming whether to link to the target web page address;
upon reception of a confirmation for linking to the target web page address from the user, cause the target web page address to be linked.

19. The terminal device according to claim 18, wherein the confirming request contains the representation of the data traffic amount corresponding to the target web page address to be linked.

20. The terminal device according to claim 12, wherein the memory further includes instructions that when executed, cause the processor to:
generate a data traffic amount report including one or more web page addresses that have been accessed and corresponding data traffic amounts resulted by accessing the web page addresses; and
upload the generated data traffic amount report to the server.
